(19) United States
(12) Patent Application Publication
(10) Pub. No.: US 2022/0405574 A1
(43) Pub. Date: Dec. 22, 2022

(54) MODEL-AWARE DATA TRANSFER AND STORAGE

(71) Applicant: INTERNATIONAL BUSINESS MACHINES CORPORATION, Armonk, NY (US)

(72) Inventors: Luis Angel Bathen, Placentia, CA (US); Sandeep Gopisetty, Morgan Hill, CA (US); Divyesh Jadav, San Jose, CA (US); Kunal Chawla, Atlanta, GA (US)

(21) Appl. No.: 17/351,628

(22) Filed: Jun. 18, 2021

(51) Int. Cl. G06N 3/08; G06F 8/60; G06N 3/04

(52) U.S. Cl. CPC G06N 3/08; G06F 8/60; G06N 3/04

(57) ABSTRACT

Methods and systems for training a neural network include transmitting a first request for training data. The request includes information about the training data and information about a neural network model. A reduced training dataset is received that includes minimal viable data, responsive to the first request. A reconstructed training dataset is generated from the reduced training dataset. The model is trained using the reconstructed dataset.

### BACKGROUND

The present invention generally relates to training data management for machine learning systems, and, more particularly, to model-aware data management that reduces the burden of storing and transferring extraneous data.

The growing prevalence of machine learning systems that make use of deep learning has led to a wide variety of new applications. Devices may be deployed with the ability to perform, for example, object detection, motion detection, etc., using a pre-trained machine learning model that accepts an input and efficiently outputs an appropriate response, such as a classification or a set of relevant features.

The performance of such models tends to increase with the size of the dataset that is used to train the model. Additionally, it can be advantageous to retrain the model responsive to changing conditions, for example when a change occurs to the kind of input that is expected. However, when training datasets are stored in a place that is separate from where the model is trained, transmitting a requested training dataset may be particularly time consuming, especially when the training dataset is large.

### SUMMARY

A method for training a neural network includes transmitting a first request for training data. The request includes information about the training data and information about a neural network model. A reduced training dataset is received that includes minimal viable data, responsive to the first request. A reconstructed training dataset is generated from the reduced training dataset. The model is trained using the reconstructed dataset. This method advantageously avoids the large amount of time that it would take to transmit the entire requested dataset, by only working with the reduced training dataset.

A particular method for training a neural network further adds filler data to the reduced training dataset to match an input data format for the model. This advantageously replicates the expected format of the requested training dataset, even though information may have been removed to generate the reduced training dataset.

A particular method for training a neural network further tests the trained model to determine whether the trained model has an accuracy that is within a predetermined threshold from an expected accuracy of the model as trained on a full dataset. This advantageously identifies situations where the reduced training data has been reduced too far.

A particular method for training a neural network further transmits a second request for training data, responsive to a determination that the trained model has an accuracy that is outside the predetermined threshold from the expected accuracy. The second request includes a relaxed data reduction parameter as compared to the first request. This advantageously responds to the receipt of a reduced training data that did not produce an acceptably accurate trained model.

A system for training a neural network includes a hardware processor and a memory that stores a computer program product. When executed by the hardware processor, the computer program product causes the hardware processor to transmit a first request for training data, the request including information about the training data and information about a neural network model, to receive a reduced training dataset that includes minimal viable data, responsive to the first request, to generate a reconstructed training dataset from the reduced training dataset, and to train the model using the reconstructed dataset. This system advantageously avoids the large amount of time that it would take to transmit the entire requested dataset, by only working with the reduced training dataset.

A particular system for training a neural network further adds filler data to the reduced training dataset to match an input data format for the model. This advantageously replicates the expected format of the requested training dataset, even though information may have been removed to generate the reduced training dataset.

A particular system for training a neural network further tests the trained model to determine whether the trained model has an accuracy that is within a predetermined threshold from an expected accuracy of the model as trained on a full dataset. This advantageously identifies situations where the reduced training data has been reduced too far.

A particular system for training a neural network further transmits a second request for training data, responsive to a determination that the trained model has an accuracy that is outside the predetermined threshold from the expected accuracy. The second request includes a relaxed data reduction parameter as compared to the first request. This advantageously responds to the receipt of a reduced training data that did not produce an acceptably accurate trained model.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a system for accessing training data from a repository, training a machine learning model at a model training system, and deploying the trained model to an edge device, in accordance with an embodiment of the present invention;

FIG. 2 is a block/flow diagram of a method for training a machine learning model using a reduced training dataset, in accordance with an embodiment of the present invention;

FIG. 3 is a block/flow diagram of a method of identifying a form of data reduction for a training dataset, in accordance with an embodiment of the present invention;

FIG. 4 is a block/flow diagram of a method for performing data reduction on a training dataset, in accordance with an embodiment of the present invention;

FIG. 5 is a block/flow diagram of a method for training a model using a reduced training dataset, in accordance with an embodiment of the present invention;

FIG. 6 is a block diagram of a training data repository system that performs data reduction on requested training datasets, in accordance with an embodiment of the present invention;

FIG. 7 is a block diagram of a model training system that requests a reduced training dataset and trains a model using the reduced training dataset, in accordance with an embodiment of the present invention;

FIG. 8 is a block diagram of an illustrative neural network model that may be trained using a reduced training dataset, in accordance with an embodiment of the present invention;

FIG. 9 is a block diagram showing an illustrative cloud computing environment having one or more cloud computing nodes with which local computing devices used by cloud consumers communicate in accordance with one embodiment; and

FIG. 10 is a block diagram showing a set of functional abstraction layers provided by a cloud computing environment in accordance with one embodiment.

### DETAILED DESCRIPTION

Rather than transferring an entire training dataset when training a model, it is possible to extract relevant information from the training dataset. This relevant information may then be transferred to a location where a machine learning model is being generated, where it may be used to perform training on the machine learning model. By removing information that is not useful to the training process for the particular type of model in question, the time needed to transfer the information, and hence the speed of retraining, may be improved. The amount of storage space needed at the point of training may similarly be reduced. Furthermore, because information is removed that does not affect the training process for the model in question, the performance of the model is not substantially affected.

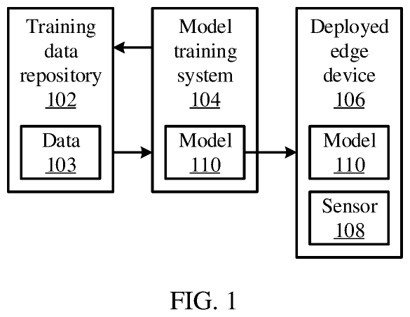

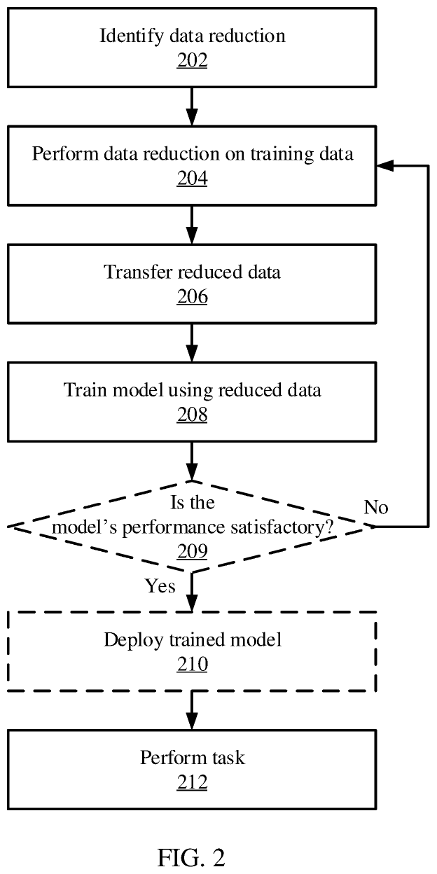

Referring now to FIG. 1, a system is shown that includes a training data repository 102, a training system 104, and a deployed edge device 106. Although the training system 104 and the deployed edge device 106 are shown herein as being separate devices, they may also be implemented in a single device.

The deployed edge device 106 performs a function that makes use of a trained neural network model. For example, the deployed edge device 106 may include one or more sensors 108, such as a camera, a passive infrared motion detector, an environmental sensor (e.g., thermometers, light level sensors, hygrometers, etc.), or a software sensor (e.g., collecting system logs, collecting system event information, etc.). The deployed edge device 106 thus collects information and uses that information as input to a trained machine learning model 110. The output of the trained machine learning model 110 may be used to trigger an action, or may be transmitted to another system for further processing or action.

For example, in one specific embodiment, the deployed edge device 106 may perform object tracking in video data. The sensor 108 may thus include a video camera that generates a video stream, and the trained machine learning model 110 may identify images of people within the video stream and tracks the motion of such people across successive frames of the video. The deployed edge device 106 may then use the tracking information to trigger an action, such as triggering a security action (e.g., locking or unlocking a door, sounding an alarm, opening a gate, etc.) or activating a device to respond to the presence of a person (e.g., turning on lights, activating a speaker, etc.). Other types of machine learning model are contemplated. For example, any form of object detection and tracking, motion detection, anomaly detection, classification, speech processing, and any other type of function may be performed by an appropriate machine learning model.

The data 103 that is stored in the training data repository 102 may be extensive. For example, there exist a variety of publicly available training data repositories, including various different data types. Such data types may include discrete images, videos, text corpuses, example log files, audio sequences, and any other type of data that may used for an appropriate machine learning model.

The data 103 may include substantially more information than that which is used in the function of the deployed edge device 106. For example, a video that is used to train a model for object tracking may have a static background, across which the object may move. For a model that focuses on the motion information of such a video, the static background may very little effect on the performance of the ultimate model. Thus, when the data 103 is transferred to the model training system 104, the amount of information that is transmitted may be far larger than what is actually needed to perform the training.

To address this problem, the training data repository 102 may perform a data reduction action before transmitting the data 103 to the model training system 104. This data reduction action may depend on the particular relationship between the data 103 and the model 110, in particular relating to the function that the model 110 is to perform and the different types of information that are encoded in the data 103.

The data reduction that is performed may therefore be made responsive to a determination of the type of model to be used and the type of data that is requested. Thus, the model training system 104 may transmit information to the training data repository 102 in a request for a set of training data, and that request may specify a type of data, a type of model it will be used for, a training process, and/or any other information which may help in performing the data reduction. In some cases, the determination of the type of data reduction may be determined by the model training system 104 and may be included in the request.

The training data repository 102 performs this data reduction before answering the request. For example, feature extraction may be performed on the data 103 to identify features that are relevant to the training, and these extracted features may be transmitted in lieu of the entire dataset. For image-based data, the data reduction may be based on a region of interest, where only information that pertains to that region of interest need be preserved. For video data, motion vectors may be selected from the regions of interest, rather than preserving them across the entire frame. Particular examples of data reduction will be described in greater detail below.

The relationship between the model, the data type, and the form of the data reduction may be determined in advance, for example by the creator of the machine learning model. In some cases, the data reduction may be determined automatically, based on information regarding the type of data that is requested and a type of function performed by the machine learning model. This may arise from predetermined relationships. For example, a model that performs object tracking in a video may benefit from a region-of-interest—based data reduction, regardless of the particulars of how the model operates. Thus, a database of such relationships may be generated in advance to associate particular forms of data reduction with particular types of training data and model functionality.

For example, a given dataset, of a given data type, may be used to train different models, with different tasks. Thus, the data 103 may be used to train multiple different models to perform the same task, multiple different tasks using the same model, as well as multiple different tasks using different models. The data 103 may include a raw datatype, or may be encoded according to a lossless or lossy compression format. The data 103 may further be annotated, for example using labels to identify key features, such as classifications.

For the model 110 itself, it is specifically contemplated that the model 110 may include an artificial neural network (ANN). The structure of ANNs will be described in greater detail below, but it should be emphasized that different tasks may be best served by a wide variety of different ANN structures.

Referring now to FIG. 4, a method for training a model to perform a task, using data reduction on the training data, is shown. Block 202 identifies a form of data reduction to perform. As will be described in greater detail below, block 202 identifies the type of model and the type of data that is being requested, and uses this information to select a type of data reduction that will reduce the size of the training data that may be used to train the model, without substantially hurting performance.

Block 204 performs the identified data reduction on the requested training data. As described in greater detail below, this may include any of a variety of different data reduction processes, but in each case some element(s) of the training data is recognized as being important to the efficacy of the training process, and these elements are preserved in the reduced dataset, while unimportant elements are discarded. Block 206 then transfers the reduced data, for example from the training data repository 102 to the model training system 104.

Block 208 performs a training process on a model 110, using the reduced data. Because the important elements of the original data have been preserved, the trained model 110 retains good performance, despite being trained on a smaller volume of data. Block 209 may then test the model, to determine whether the model's performance is satisfactory, having been trained on a reduced dataset. The determination of satisfactory performance may include comparing an accuracy of the model's output to an expected accuracy for models that are trained on the full dataset, for example by finding whether the accuracy falls within a threshold distance of the expected accuracy. This step may be omitted for forms of data reduction that have been tested previously and have been shown to provide good results. If the trained model's performance is not satisfactory, then data reduction may be repeated in block 204, for example using more permissive data reduction parameters that reproduce a larger portion of the original data.

This trained model may be deployed, in block 210, to an edge device 106. In embodiments where the model training system 104 is integrated with the deployed edge device 106, the transmission of the model between discrete systems may be omitted. The model 110 is then used by block 212 to perform a task, for example using information from a sensor 108 to generate the model's input.

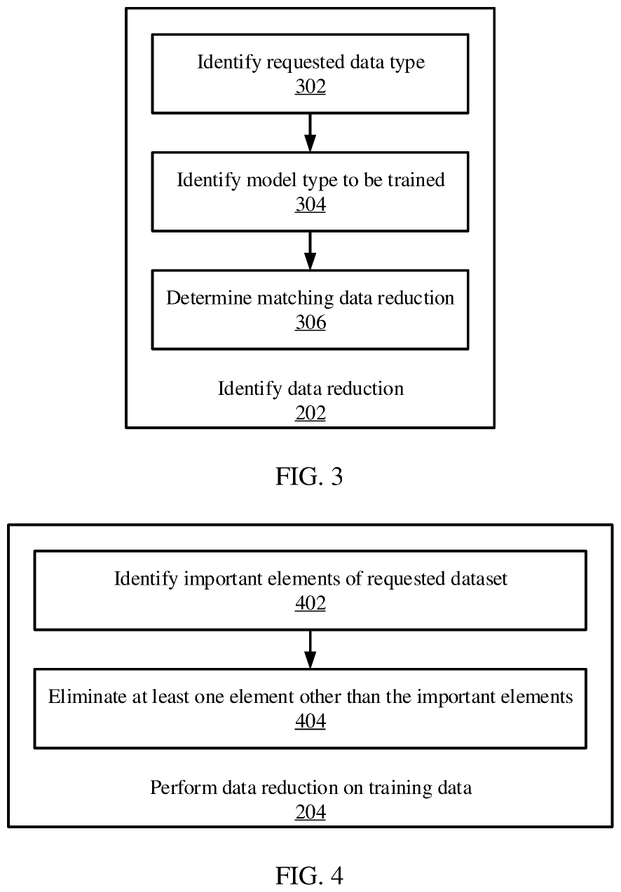

Referring now to FIG. 3, additional detail on the identification of a data reduction process in block 202 is shown. This identification may be performed at the training data repository 102, responsive to a request from the model training system 104, or may be performed at the model training system 104 itself. Block 302 identifies a requested data type. For example, such data types may include image or video data, audio data, text data, etc. Block 304 identifies a model type that is to be trained using the requested data. This identification of model type may include, for example, information about the structure of the model 110 itself. The identification of model type may also, or alternatively, include information about the intended function that the model 110 will perform, such as object detection and tracking, anomaly detection, log processing, speech recognition and processing, etc.

Block 306 determines a data reduction process that matches the identified data type and model type. This determination may be made by, for example, accessing a lookup table that stores correspondences between data reduction processes, data types, and model types. In some cases, information about the model type and data type may be analyzed to identify an appropriate data reduction process, even if the requested combination is not explicitly provided for in a lookup table.

Identification of the data reduction process may be at least partially automated. For example, a feature extraction engine may be supplied with the information that, for example, moving objects or particular types of objects are sought. In one specific example, if cars are to be detected, then an object may be used to identify the bounding boxes of regions of interest that include a car. Then, only the information relating to the identified cars may be extracted. In another example, if moving objects are being tracked, then only motion vectors may be extracted. In another example, with textual data, policies may be determined with regular expressions.

Referring now to FIG. 4, additional detail on the performance of a data reduction process in block 204 is shown. Block 402 identifies important elements of the requested dataset, and block 404 eliminates at least one element from the dataset, other than the important elements. Block 404 may include making a copy of the original dataset, so that the reduced dataset may be stored alongside the full, original dataset. Block 404 seeks to generate a dataset that includes only the minimal viable data (MVD) that can be used to effectively train the model 110.

Rather than using an existing methodology, block 402 and 404 may identify a new type of data or model, for example, that may benefit from a new type of data reduction. In such cases, these steps may incorporate any appropriate data reduction. For example, from still images of a video, object detectors may extract regions of interest, and mini-frames may be reconstructed on the basis of the regions of interest.

The Exact steps that are performed by blocks 402 and 404 will depend on the data reduction process that is selected, which in turn depends on the type of model 110 and the type of requested data 103. For images and video, where object detection or tracking is being performed, the important elements may be regions of interest or objects within an image or sequence of images. For audio data, where anomalous sounds are identified by the model, the important elements may be particular frequencies of sound that relate to anomalous behavior. For text, such as in log processing, large volumes of the log data may be made up by common, normal occurrences, which may be removed or summarized in favor of the rare entries that carry significant information.

The identification of important elements in block 402 may be responsive to a control parameter that determines how strict the data reduction process will be. For example, the identification of regions of interest may vary according to how closely the region of interest conforms to a particular object, including more or less of the background information. Thus, as the model 110 is tested and the training is repeated, this control parameter may be varied to change how much information the data reduction process discards.

In some examples, the model 110 may perform the task of tracking an object of interest across frames of a video. For example, in a video of a sporting event, the model 110 may seek to identify a ball in the video and to track the ball's progress as the video goes on. Training such a model 110 may include two stages—one to identify regions of each video frame that includes the ball, and a second to connect those identified regions across consecutive frames. Thus, for training data that includes video data, with balls being identified where they occur in the frames of the video data, block 402 may select the regions that are identified as including a ball.

Following the example of tracking a ball, block 404 may take advantage of the motion information used to compress video data. For example, many forms of video encoding use different types of frame, including an intra-coded frame (I-frame), a predictive frame (P-frame), and a bidirectional predictive frame (P-frame). Whereas the I-frame may represent a complete image, with fully defined pixel image for every point in the frame, P-frames and B-frames may make reference to previous frames, or to frames coming before and after, to infer what the pixel values of these frames should be. In this manner, the amount of information that needs to be transmitted can be greatly reduced, and the video stream can be compressed.

In some cases, these video compression systems make use of motion vector information, which indicates how a particular pixel (or group of pixels) in one frame may appear in a previous or subsequent frame. As a ball moves across a fixed background in a video stream, pixels that make up the ball may be represented in P-frames and B-frames according to how those pixels from another image evolve through time. Taking a simple example, a ball that moves from left to right over the course of a video will have a first position in an I-frame, with a second position in a following P-frame being defined according to motion vectors associated with the pixels in the I-frame. Thus, to encode the P-frame, all that would need to be transmitted are the motion vectors that explain how to modify the I-frame to reproduce the image of the P-frame.

These motion vectors may be used to capture the MVD of the training data. Rather than transmitting the entire video stream, which may be large even when compressed as above, the motion vectors may be used to identify how a motion of interest moves through the video. Base frames may be transmitted as well, to reconstruct the object during training.

In another example, data reduction may extract only the needed optical flow information from a video to be used in training. For example, in a video that records the motion of vehicles across a scene, the data reduction may identify silhouettes of the vehicles and may determine how those silhouettes move over time. Any additional information, such as background textures, and even features of the vehicles themselves, may be omitted.

As another example, data may be dynamically optimized. For example, images may be processed using wavelet transforms, with a base image being stored at an original resolution x. In such a compression scheme, an original image may be high-pass filtered three times to capture changes in brightness for different colors. The original image may then be low-pass filtered and downscaled, to provide an approximation image. The approximation image may then be high-pass filtered to produce three smaller-detail images, and then low-pass filtered to produce a final approximation image. These different filtered images may be used to reconstruct the original image, or to provide intermediate reconstructions at different scales. Given the needs of the model 110, different transformed parts may be selected in accordance with the scale needed to reconstruct the image. Given a region of interest, only the coefficients needed to reconstruct the region of interest at a given scale may be stored and transmitted.

For audio data, the frequencies of the original audio may be limited to only those frequencies which are relevant to the model. For example, in a model that deals with speech information, only those frequencies that make up human speech may be preserved during data reduction, thereby making it possible to reduce the bit rate of the audio information. Similarly, for audio that is used in anomaly detection for a physical system, then normal and anomalous operation of the machine may be limited to particular regions of the audio spectrum, and the audio data may be limited to these regions.

For text data, such as log data, common passages may be represented according to a template, which may omit large amounts of information that would otherwise be irrelevant to the operation of the model 110. Such templates may identify log entry formats and may replace portions of the log entries with a placeholder.

In each case, the particular type of data reduction may be identified according to the model and the type of information that it needs to perform its task. These correspondences may be stored in a lookup table or database, according to a predetermined identification of appropriate types of data reduction in various contexts. In some cases, the correspondences may be determined automatically, in accordance with an analysis of the data type that is requested and the model information.

For a new type of data reduction, for example based on a previously unknown type of data in the dataset, a user may provide a partial annotation of the dataset, such as by identifying particular objects within some of the data. The remainder of the dataset may then be annotated, using machine learning based on the partial annotation. The user may alternatively provide a complete annotation of the dataset. In either case, one an annotated dataset is available, the user may supply an identification of the type of annotations that are to be used for a particular data reduction. Thus, data reduction that is based on identification of regions of interest or detection of particular objects may be automatically determined from a template, for example that describes how to perform data reduction for a general type of region or object.

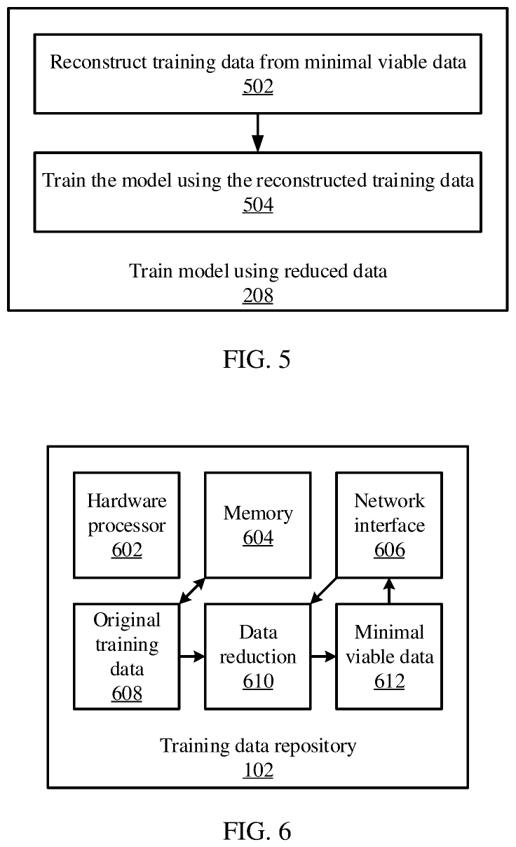

Referring now to FIG. 5, additional detail on training the model 110 using the reduced data is shown for block 208. Using the MVD, block 502 reconstructs the training data. For example, if the MVD includes a set of regions of interest from each of the frames of a video, block 502 may insert these regions into an image that is the same size of the original frames, with filler data (e.g., a particular pixel color for an image) being used to fill in the remainder of the frame. Block 504 then trains the model 110 using the reconstructed training data, in the same manner as if it were being trained using the full original dataset.

Notably, the reconstructed training data may differ from the original training data, as some information may be lost during data reduction. However, because the important data has been transmitted, the reconstructed training data will provide suitable results during training of a model.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C).

This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Referring now to FIG. 6, additional detail on training data repository 102 is shown. The repository 102 includes a hardware processor 602 and a memory 604, as well as one or more functional components. The functional components may be implemented in the form of, e.g., software that is stored in the memory 604 and that is executed by the hardware processor 602 to perform their respective functions. In some cases, one or more of the functional components may be implemented in the form of one or more discrete hardware components, for example in the form of ASICs or FPGAs. A network interface 606 provides communication between the training data repository 102 and the model training system 104, and may use any appropriate wired or wireless communications medium and protocol.

Original training data 608 is stored in the memory 604. Data reduction 610 accepts a request from the model training system 104, via the network interface 606, and determines a type of data reduction to perform on the original training data 608. Data reduction 610 then uses this data reduction process to generate minimal viable data 612, which may be transmitted to the model training system 104 using the network interface 606.

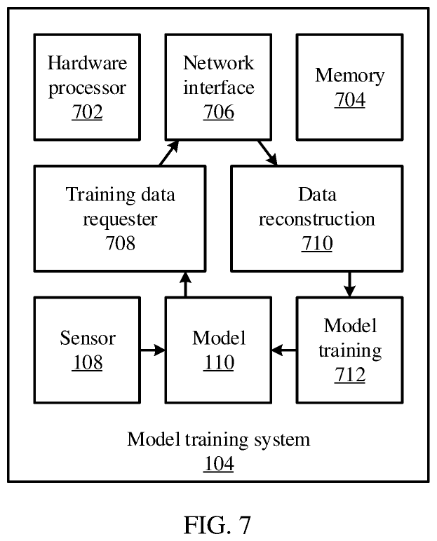

Referring now to FIG. 7, additional detail on the model training system 104 is shown. The system 104 includes a hardware processor 702 and a memory 704, as well as one or more functional components. The functional components may be implemented in the form of, e.g., software that is stored in the memory 704 and that is executed by the hardware processor 702 to perform their respective functions. In some cases, one or more of the functional components may be implemented in the form of one or more discrete hardware components, for example in the form of ASICs or FPGAs. A network interface 706 provides communication between the training data repository 102 and the model training system 104, and may use any appropriate wired or wireless communications medium and protocol.

A training data requester 708 generates a request for training data that is sent to the training data repository 102 using the network interface 706. The request may include information relating to the model 110, including information about the structure and function of the model 110, and may also include information relating to the data, including data type. The training data repository 102 generates a set of minimal viable data, which it transmits to the model training system 104 and which is received using the network interface 706. Data reconstruction 710 generates a set of training data based on the MVD.

Model training 712 is performed using the reconstructed training data, thereby updating parameters of the model 110 to perform its function. Model training 712 may further test the model for efficacy, and may send an updated request through the training data requester 708 to adjust the data reduction that is performed at the training data repository 102.

In embodiments where the deployed edge device 106 is integrated with the model training system 104, once the model 110 is trained, it may be used to perform a task, for example using input data from a sensor 108. In embodiments where the deployed edge device 106 is separate from the model training system 104, the trained model 110 may be transmitted to the deployed edge device 106, for example using the network interface 706.

As noted above, the model 110 may be implemented as an ANN. An ANN is an information processing system that is inspired by biological nervous systems, such as the brain. One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

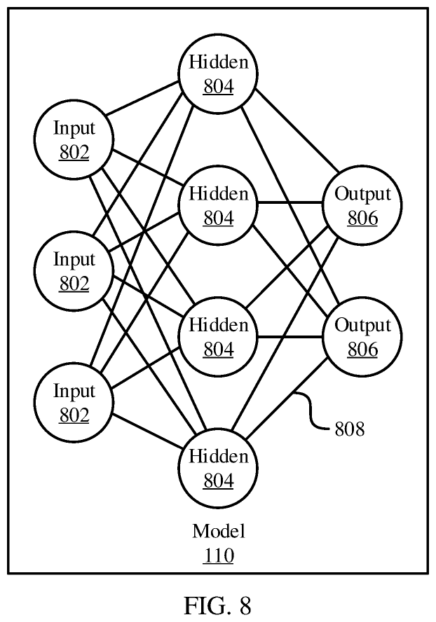

Referring now to FIG. 8, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 802 that provide information to one or more “hidden” neurons 804. Connections 808 between the input neurons 802 and hidden neurons 804 are weighted, and these weighted inputs are then processed by the hidden neurons 804 according to some function in the hidden neurons 804. There can be any number of layers of hidden neurons 804, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 806 accepts and processes weighted input from the last set of hidden neurons 804.

This represents a “feed-forward” computation, where information propagates from input neurons 802 to the output neurons 806. Upon completion of a feed-forward computation, the output is compared to a desired output available from training data. The error relative to the training data is then processed in “backpropagation” computation, where the hidden neurons 804 and input neurons 802 receive information regarding the error propagating backward from the output neurons 806. Once the backward error propagation has been completed, weight updates are performed, with the weighted connections 808 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 808 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 808 may be implemented as resistive processing units (RPUs), generating a predictable current output when an input voltage is applied in accordance with a settable resistance.

The model 110 shown in FIG. 8 is presented as a particularly simple structure, and it should be understood that the structure of the model may be any appropriate neural network structure. For example, a first object detection model may make use of a convolutional neural network (CNN) with a region proposal network (RPN) to identify regions and to fine-tune object detection. This first object detection model may use the CNN to identify feature maps, while the RPN uses the feature maps to propose regions of interest. Pooling may be performed on the regions of interest, and the result may be provided to a classifier.

A second object detection model may use a single shot detector structure, where a pyramid structure of successively smaller CNN layers process an input for varying receptive fields. Objects may be detected at each layer, with fine layers being used to identify smaller objects.

A third object detection model may use a “you only look one” structure, where an image is split into square cells, with a fixed number of bounding boxes per cell. The number of bounding boxes may be predicted using a CNN layer.

CNNs process information using a sliding “window” across an input, with each neuron in a CNN layer having a respective “filter” that is applied at each window position. Each filter may be trained, for example, to handle a respective pattern within an input. CNNs are particularly useful in processing images, where local relationships between individual pixels may be captured by the filter as it passes through different regions of the image. The output of a neuron in a CNN layer may include a set of values, representing whether the respective filter matched each set of values in the sliding window.

While CNNs are useful for multi-dimensional data, such as images, other types of ANN structure may be more useful for other types of data. For example, recurrent neural networks (RNNs) may be used to process sequences of information, such as an ordered series of feature vectors. This makes RNNs well suited to text processing and speech recognition, where information is naturally sequential. Each neuron in an RNN receives two inputs: a new input from a previous layer, and a previous input from the current layer. An RNN layer thereby maintains information about the state of the sequence from one input to the next.

Thus, the structure of the model itself provides hints for how the original data may be reduced. For example, if the model 110 is not equipped to handle certain kinds of input, then those inputs may be removed from the training data before it is transmitted to the model training system 104.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

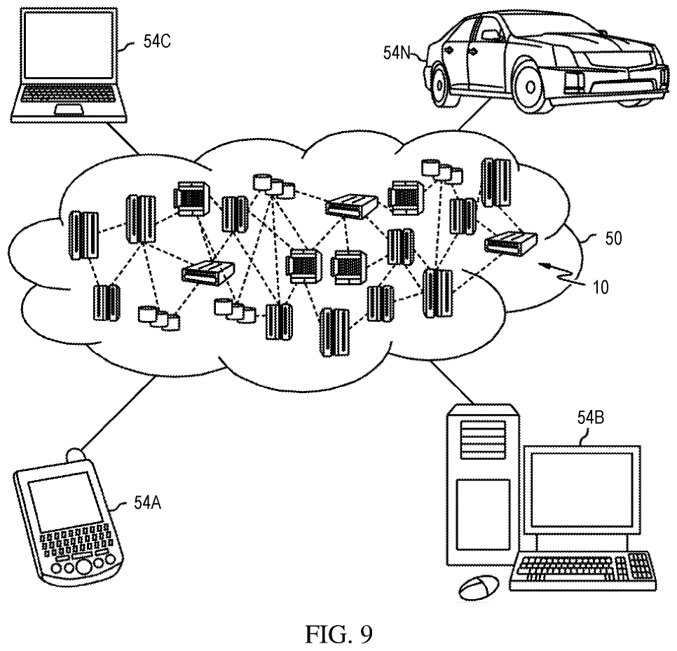

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

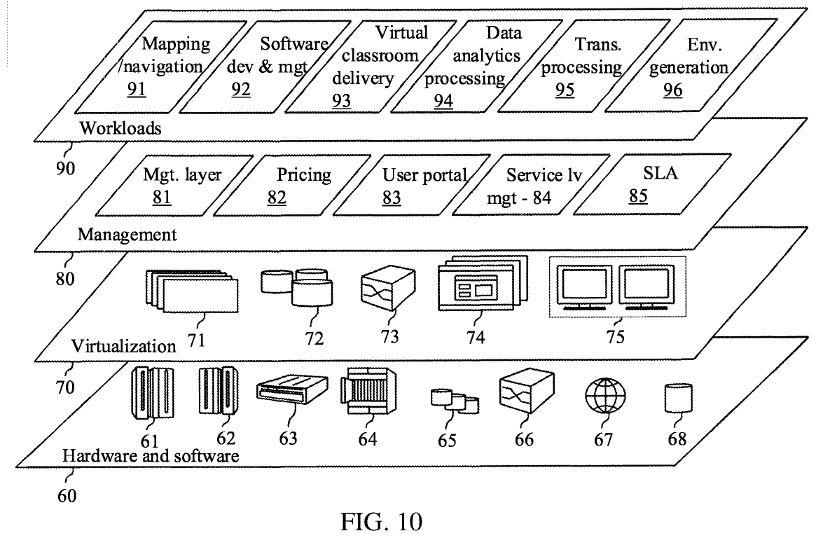

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and machine learning model training 96.

Having described preferred embodiments of model-aware data transfer and storage (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for training a neural network, comprising:
transmitting a first request for training data, the request including information about the training data and information about a neural network model;
receiving a reduced training dataset that includes minimal viable data, responsive to the first request;
generating a reconstructed training dataset from the reduced training dataset; and
training the model using the reconstructed dataset.

2. The method of claim 1, wherein generating the reconstructed dataset includes adding filler data to the reduced training dataset to match an input data format for the model.

3. The method of claim 1, wherein information about the model comprises at least one element selected from the group consisting of a function of the model and a structure of the model.

4. The method of claim 1, further comprising testing the trained model to determine whether the trained model has an accuracy that is within a predetermined threshold from an expected accuracy of the model as trained on a full dataset.

5. The method of claim 4, further comprising transmitting a second request for training data, responsive to a determination that the trained model has an accuracy that is outside the predetermined threshold from the expected accuracy, the second request comprising a relaxed data reduction parameter as compared to the first request.

6. The method of claim 5, further comprising:
receiving a second reduced training dataset, responsive to the second request;
generating a second reconstructed dataset from the second reduced training dataset; and
retraining the model using the second reconstructed dataset.

7. The method of claim 1, further comprising deploying the trained model to an edge device for implementation.

8. The method of claim 1, wherein the reduced training dataset does not include at least some information from an original dataset that does not affect the efficacy of the model.

9. The method of claim 1, wherein the minimal viable data comprises motion vector information.

10. A computer program product for training a neural network model, the computer program product comprising a computer readable storage medium having program instructions embodied therewith, the program instructions being executable by a hardware processor to cause the hardware processor to:
transmit a first request for training data, the request including information about the training data and information about a neural network model;
receive a reduced training dataset that includes minimal viable data, responsive to the first request;
generate a reconstructed training dataset from the reduced training dataset; and
train the model using the reconstructed dataset.

11. A system for training a neural network, comprising:
a hardware processor; and
a memory that stores a computer program product, which, when executed by the hardware processor, causes the hardware processor to:
transmit a first request for training data, the request including information about the training data and information about a neural network model;
receive a reduced training dataset that includes minimal viable data, responsive to the first request;
generate a reconstructed training dataset from the reduced training dataset; and
train the model using the reconstructed dataset.

12. The system of claim 11, wherein generating the reconstructed dataset includes adding filler data to the reduced training dataset to match an input data format for the model.

13. The system of claim 11, wherein information about the model comprises at least one element selected from the group consisting of a function of the model and a structure of the model.

14. The system of claim 11, further comprising testing the trained model to determine whether the trained model has an accuracy that is within a predetermined threshold from an expected accuracy of the model as trained on a full dataset.

15. The system of claim 14, further comprising transmitting a second request for training data, responsive to a determination that the trained model has an accuracy that is outside the predetermined threshold from the expected accuracy, the second request comprising a relaxed data reduction parameter as compared to the first request.

16. The system of claim 15, further comprising:
receiving a second reduced training dataset, responsive to the second request;
generating a second reconstructed dataset from the second reduced training dataset; and
retraining the model using the second reconstructed dataset.

17. The system of claim 11, further comprising deploying the trained model to an edge device for implementation.

18. The system of claim 11, wherein the reduced training dataset does not include at least some information from an original dataset that does not affect the efficacy of the model.

19. The system of claim 11, wherein the minimal viable data comprises motion vector information.

20. The system of claim 11, wherein the minimal viable data comprises region of interest information.
